(19) United States
(12) Patent Application Publication
(10) Pub. No.: US 2003/0003315 A1
(43) Pub. Date: Jan. 2, 2003

(54) Film and laminate

(75) Inventors: Hiroaki Takahata, Ichihara-shi (JP); Yasuyuki Takagi, Ichihara-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY, LIMITED

(21) Appl. No.: 10/152,049

(22) Filed: May 22, 2002

(30) Foreign Application Priority Data
Jun. 29, 2001 (JP) 2001-198642

(51) Int. Cl. B32B 27/08

(52) U.S. Cl. 428/516; 428/517; 428/520; 428/497

(57) ABSTRACT

There are provided:

(I) a film having a layer which layer comprises a resin composition containing:

(A) 100 parts by weight of at least one resin selected from the group consisting of a rubber modified polystyrene resin and a polystyrene resin,

(B) 120 to 1700 parts by weight of an ethylene-unsaturated carboxylic acid ester copolymer, and

(C) 10 to 250 parts by weight of at least one tackifier selected from the group consisting of an alicyclic hydrocarbon resin, a terpene resin, a rosin and an aliphatic hydrocarbon resin, the tackifier having a number average molecular weight of not more than 1500 measured by a gel permeation chromatography, provided that at least one outermost layer of the film is the layer comprising said resin composition, and

(II) a laminate comprising:

(1) a layer (1) comprising the above-mentioned film (I), and

(2) a substrate layer (2), provided that at least one outermost layer of the laminate is the layer (1).

### FIELD OF THE INVENTION

The present invention relates to a film suitably used for applications such as a cover for a container and a wrapping bag, and to a laminate comprising a layer containing said film and a substrate layer.

### BACKGROUND OF THE INVENTION

A cover for a container is required to have not only a function as protecting contents but also facility of unsealing. As a material for such a cover, there is known an easy-peeling film, which comprises a resin composition containing different kinds of resins. For example, JP-A 11-92605 discloses an easy-peeling film, which comprises a resin composition containing (i) a styrene resin, (ii) an olefin resin having a solubility parameter of 8.45 to 8.70, and containing no repeating unit derived from an aromatic vinyl compound (hereinafter called like “aromatic vinyl compound unit”), and (iii) another olefin resin different from the above-mentioned olefin resin.

When the above-mentioned easy-peeling film is used as a cover for a container, it can exhibit a mostly good sealing property and an easy-unsealing property, namely, easy-peeling property. However, said film has a problem that when sealed in a condition that a liquid contaminant exists on a sealing surface, the film is insufficient in its sealing property.

### SUMMARY OF THE INVENTION

An object of the present invention is to provide a film, which exhibits a good sealing property and an easy-peeling property under usual sealing conditions, and which exhibits a good sealing property even in a condition that a liquid contaminant exists on a sealing surface.

Another object of the present invention is to provide a laminate, which comprises a layer containing said film and substrate layer.

In the present invention, a sealing property, which is exhibited when a film is applied in a condition that a liquid contaminant exists on a sealing surface, is called sealing property of a film having a liquid contaminant on its surface (hereinafter, abbreviated as “liquid-existing sealing property”).

The present inventors have undertaken extensive studies to accomplish the above-mentioned objects. As a result. it has been found that the objects of the present invention can been accomplished by using a resin composition comprising (i) a styrene unit-containing specific resin, (ii) an ethylene-unsaturated carboxylic acid ester copolymer and (iii) a specific tackifier in a specific blending ratio. Thereby, the present invention has been obtained.

The present invention provides a film having a layer, which layer comprises a resin composition containing:

(A) 100 parts by weight of at least one resin selected from the group consisting of a rubber modified polystyrene resin and a polystyrene resin,

(B) 120 to 1700 parts by weight of an ethylene-unsaturated carboxylic acid ester copolymer, and

(C) 10 to 250 parts by weight of at least one tackifier selected from the group consisting of an alicyclic hydrocarbon resin, a terpene resin, a rosin and an aliphatic hydrocarbon resin, the tackifier having a number average molecular weight of not more than 1500 measured by a gel permeation chromatography, provided that at least one outermost layer of the film is the layer comprising said resin composition.

The present invention also provides a laminate comprising:

(1) a layer (1), and

(2) a substrate layer (2).

wherein the layer (1) comprises a film having a layer (a), which layer (a) comprises a resin composition containing:

(A) 100 parts by weight of at least one resin selected from the group consisting of a rubber modified polystyrene resin and a polystyrene resin,

(B) 120 to 1700 parts by weight of an ethylene-unsaturated carboxylic acid ester copolymer, and

(C) 10 to 250 parts by weight of at least one tackifier selected from the group consisting of an alicyclic hydrocarbon resin, a terpene resin, a rosin and an aliphatic hydrocarbon resin, the tackifier having a number average molecular weight of not more than 1500 measured by a gel permeation chromatography, provided that:

(i) at least one outermost layer of the film is the layer (a) comprising said resin composition, and

(ii) at least one outermost layer of the laminate is the layer (1).

### DETAILED EXPLANATION OF THE INVENTION

When a content of the component (B) contained in the resin composition used in the present invention is less than 120 parts by weight, or when a content of the component (C) contained therein is less than 10 parts by weight, the obtained film does not have a sufficient low temperature sealing property and a sufficient liquid-existing sealing property. When a content of the component (B) contained in the resin composition is more than 1700 parts by weight, or when a content of the component (C) contained therein is more than 250 parts by weight, the obtained film deteriorates in its anti-blocking property.

The “rubber modified polystyrene resin” used in the present invention means a resin generally referred to as a high impact polystyrene (HIPS). Said resin can be produced, for example, by polymerizing at least one monomer selected from the group consisting of styrene and its derivatives in the presence of a rubbery polymer. The resin has a morphology composed of (1) a continuous phase of a polymer containing a unit of at least one monomer selected from the group consisting of styrene and its derivatives, and (2) a dispersed phase of the rubbery polymer. A content of the rubbery polymer contained in said resin is generally from about 5 to 25% by weight. As the above-mentioned monomer, there are exemplified styrene and various α-alkyl substituted styrenes such as α-methylstyrene. As the above-mentioned rubbery polymer, there are exemplified polybutadiene, a styrene-butadiene copolymer, polyisoprene and a styrene-isoprene copolymer.

The “polystyrene resin” used in the present invention means a resin generally referred to as a general purpose polystyrene (GPPS), which contains a unit of at least one monomer selected from the group consisting of styrene and its derivatives. Said resin can be produced, for example, by polymerizing at least one above-mentioned monomer. As the above-mentioned monomer, there are exemplified styrene and various α-alkyl substituted styrenes such as α-methylstyrene.

As the unsaturated carboxylic acid ester in the component (B) used in the present invention, preferred are acrylic acid esters and methacrylic acid esters such as methyl acrylate, ethyl acrylate, butyl acrylate, methyl methacrylate, ethyl methacrylate and butyl methacrylate. Of these, particularly preferred are methyl acrylate and methyl methacrylate from a viewpoint of an easy-peeling property of the film in accordance with the present invention. A content of the unsaturated carboxylic acid ester unit contained in the component (B) is preferably from 25 to 50% by weight, and more preferably from 25 to 45% by weight, based on 100% by weight of a total amount of the component (B) from viewpoints of an easy-peeling property of the film in accordance with the present invention and a good appearance of the peeled portion after peeling of the film.

A number average molecular weight measured by a gel permeation chromatography of the component (C) used in the present invention is not more than 1500, and preferably from 300 to 1000 from a viewpoint of obtaining a film having a sufficient liquid-existing sealing property. The number average molecular weight means a number average molecular weight converted into a number average molecular weight of polystyrene.

Examples of the alicyclic hydrocarbon resin of the component (C) used in the present invention are resins produced by polymerizing a cyclic dimer of a petroleum fraction such as a C4 petroleum fraction and a C5 petroleum fraction: resins produced by polymerizing a cyclic diene compound such as cyclopentadiene and their hydrogenated products; resins produced by hydrogenating an aromatic ring of an aromatic hydrocarbon resin; and resins produced by hydrogenating an aromatic ring of an aliphatic hydrocarbon-aromatic hydrocarbon copolymer resin.

Examples of the terpene resin of the component (C) used In the present invention are polymers of a compound such as α-pinene, β-pinene and dipentene and their hydrogenated products; and terpene-phenol copolymer resins.

Examples of the rosin of the component (C) used in the present invention are rosin; rosin esters; a hydrogenated rosin; hydrogenated rosin esters; and their polymerized products.

Examples of the aliphatic hydrocarbon resin of the component (C) used in the present invention are resins containing an olefin unit of 4 or 5 carbon atoms as a main unit, and resins containing a diene unit of 4 or 5 carbon atoms as a main unit.

Among these, hydrogenated resins are preferred, and hydrogenated terpene resins are particularly preferred from a viewpoint of balance between a sealing property and an easy-peeling property of the film in accordance with the present invention.

Each of the components (A), (B) and (C) used in the present invention may be used, if desired, in combination with a thermoplastic resin. Examples of the thermoplastic resin are polyethylene such as a low density polyethylene and a high density polyethylene; ethylene-α-olefin copolymers; ethylene unit-containing copolymers other than the component (B); and polyolefin resins such as polypropylene and propylene-α-olefin copolymers.

Each of the components (A), (B) and (C) used in the present invention may be used further, if desired, in combination with compatibilizers, antistatic agents, antioxidants, heat stabilizers, ultraviolet ray absorbers, pigments, dyestuffs, antibacterial agents, anti-fogging agents, lubricants, anti-blocking agents and plastisizers (such as a mineral oil).

Examples of the above-mentioned lubricant are higher fatty acid amides having 10 to 50 carbon atoms such as stearic acid amide, oleic acid amide, erucic acid amide and ethylenebisoleic acid amide. The lubricant is used in an amount of usually from 0.3 to 50 parts by weight based on 100 parts by weight of the component (A).

The above-mentioned anti-blocking agent contains inorganic or organic fine particles. As the fine particles, there are exemplified inorganic beads such as aluminosilicate beads and diatomaceous earth beads; and organic beads such as acrylic resin beads and styrene resin beads. The anti-blocking agent is used in an amount of usually from 1 to 100 parts by weight based on 100 parts by weight of the component (A).

A process for producing the resin composition used in the present invention is not limited. The resin composition can be produced according to various processes such as (1) a process comprising the steps of (i) dry-blending the components (A), (B) and (C) in a pre-determined blending ratio to obtain a blend, and (ii) melt-kneading the blend using a kneading apparatus, and (2) a process comprising the step of supplying the components (A), (B) and (C) in a pre-determined blending ratio directly to a kneading apparatus to complete a melt-kneading.

The film in accordance with the present invention may be (1) a single layered film composed of only one layer comprising the resin composition containing the components (A), (B) and (C), (2) a laminated film composed of at least two layers, each of which layers comprises each resin compositions containing the components (A), (B) and (C) in each blending ratio, and (3) a laminated film composed of at least one layer comprising the resin composition containing the components (A), (B) and (C) and at least one layer comprising other composition or material. As the other composition or material, there are exemplified a resin composition other than the resin composition containing the components (A), (B) and (C); a resin composition containing the components (A) and (B): a resin different from the components (A) and (B); a metal foil such as aluminum foil; and paper.

As a resin applicable to the above-mentioned other composition or material, there are exemplified a resin selected from the group consisting of a high density polyethylene, a low density polyethylene, a linear low density polyethylene, polypropylene, ethylene-propylene copolymers, polystyrene, a rubber modified polystyrene, polyesters and polyamides, and a resin composition comprising at least two these resins. The layer comprising these resins or resin compositions may comprise a non-oriented film, a biaxial oriented film, a film coated with an inorganic material or an organic material such as vinylidene chloride or a film having a printed surface.

When the film in accordance with the present invention is the above-mentioned single layered film, a thickness of the single layered film can be appropriately determined. Preferably, the thickness is usually from 10 to 100 μm.

A process for producing the above-mentioned single layered film is not limited. The film can be produced according to various processes such as a T-die cast-molding process, a tubular film molding process and a tenter molding process.

When the film in accordance with the present invention is a laminated film, the laminated film may be composed of two or more layers, each of which layers comprises each resin composition containing the components (A), (B) and (C). Said each resin composition may be the same or different from each another in each blending ratio of the components (A), (B) and (C).

When the film or the laminate in accordance with the present invention is applied as a cover for a container, the cover can be produced by a process comprising the step of stamping out the film or the laminate into the form of a cover. From a viewpoint of stamping out facility, it is recommendable to use a film or a laminate, which has a layer comprising a resin composition containing 100 parts by weight of the component (A), 120 to 1700 parts by weight of the component (B), 10 to 250 parts by weight of the component (C), and 200 to 900 parts by weight of an ethylene resin as the above-mentioned other material. The above-mentioned resin composition is hereinafter referred to as “resin composition (B)”. The component (A) contained in the resin composition (B) maybe different from the component (A) contained in the resin composition containing no ethylene resin as the above-mentioned other material. As the ethylene resin, there are exemplified a low density polyethylene (LDPE); ethylene-olefin copolymers (linear low density polyethylene) (LLDPE); a high density polyethylene (HDPE): and a combination of two or more thereof. Of these. LDPE and LLDPE are preferred from a viewpoint of stamping out facility.

Respective components used for the resin composition (B) may be used, if desired, in combination with a thermoplastic resin. Examples of the thermoplastic resin are an ethylene unit-containing copolymer such as ethylene-methyl acrylate copolymers, ethylene-methacrylate copolymers and ethylene-vinyl acetate copolymers, and an olefin resin such as polypropylene and propylene-α-olefin copolymers.

Respective components used for the resin composition (B) may be used further, if desired, in combination with compatibilizers, antistatic agents, antioxidants, heat stabilizers, ultraviolet ray absorbers, pigments, dyestuffs, antibacterial agents, anti-fogging agents, lubricants, anti-blocking agents and plastisizers (such as mineral oil). Examples of the compatibilizers are hydrogenated products of styrene-conjugated diene block copolymers such as a hydrogenated styrene-isoprene block copolymer (SEPS) and a hydrogenated styrene-butadiene block copolymer (SEBS). The compatibilzer is used in an amount of generally from 20 to 100 parts by weight based on 100 parts by weight of the component (A).

When the film in accordance with the present invention is a laminated film, a thickness of the laminated film can be appropriately determined as occasion demands. A preferable thickness of a layer contained in said laminated film, which layer comprises a resin composition containing no ethylene resin as the above-mentioned other material, is usually from about 5 to 50 μm from a viewpoint of an easy-peeling property of the laminated film obtained. A preferable thickness of a layer comprising the resin composition (B) is usually from about 5 to 50 μm from a viewpoint of stamping out facility of the laminated film obtained.

A process for producing the resin composition (B) is not limited. Said resin composition can be produced according to various processes such as (1) a process comprising the steps of (i) dry-blending respective components in a pre-determined blending ratio to obtain a blend, and (ii) melt-kneading the blend using a kneading apparatus, and (2) a process comprising the step of supplying respective components in a pre-determined blending ratio directly to a kneading apparatus to complete a melt-kneading.

When the film in accordance with the present invention is a laminated film, which has (i) a layer comprising a resin composition containing the components (A), (B) and (C) and (ii) a layer comprising a material other than said resin composition, such a laminated film can be produced according to various processes such as a co-extrusion T-die cast molding process, a co-extrusion tubular film molding process, a co-extrusion tenter molding process, a co-extrusion laminate molding process, an extrusion laminate molding process and a dry-laminating process.

When a laminated film is produced by a dry-laminating process wherein respective layers are bonded with each other, said process generally comprises preferably the steps of (i) treating a surface of at least one layer with a surface treatment such as a corona treatment, and (ii) bonding respective layers using an adhesive. In this case, there are exemplified, as a layer comprising a material other than a resin composition containing the components (A), (B) and (C), a non-oriented or biaxial oriented film comprising at least one polymer such as polypropylene, polyesters, polyamides and ethylene-vinyl alcohol copolymers; a film prepared by applying a coating agent to said film; and a film prepared by vapor-depositing a substance such as a metal on said film.

It is important that at least one outermost layer of the laminate of the present invention is the layer (1) comprising the film in accordance with the present invention, whereby the laminate can effectively exhibit a function as the film in accordance with the present invention. The substrate layer (2) contained in the laminate gives a property such as strength to the film contained therein. Both the film-comprising layer (1) and the substrate layer (2) may be laminated directly with each other or laminated through another layer.

A kind of a material used for the substrate layer (2) is not limited. Examples of the material are thermoplastic resin made films such as a biaxial oriented polyethylene terephthalate film (PET film) metal foils such as an aluminum foil; and paper.

A method for laminating the layer (1), the layer (2) and the other optional layer can be selected appropriately depending upon the kind of materials for respective layers. There are exemplified a laminating (bonding) method using an adhesive and a laminating (bonding) method by means of heat seal.

When the film in accordance with the present invention is used as a wrapping material, a surface of said film (which surface is an opposite surface to be heat-sealed onto an article such as a container to be wrapped) may be subjected to surface-treating such as corona-treating, coating such as printing with an ink, or vapor-depositing a substance such as a metal as occasion demands.

The film and laminate in accordance with the present invention can be processed into a desired shape such as a cover used for a cup-like container or a tray-like container. The film and laminate in accordance with the present invention can also be used as a bag-like container such as a three-side seal bag, a four-side seal bag and a standing pouch. For example, a method for wrapping an article with the three-side seal bag comprises the steps of:

(1) preparing a three-side seal bag having an opening on one side,

(2) putting an article such as a food into the bag from the opening, and

(3) sealing the opening, whereby the innermost layer of the bag, namely the layer comprising the resin composition containing the components (A), (B) and (C), can be sealed by itself.

According to the present invention, there are provided a film and a laminate, each of which has an excellent sealing property, an excellent easy-peeling property and an excellent liquid-existing sealing property for at least a styrene resin-made article and a propylene resin-made article.

More specifically, when the above-mentioned styrene resin-made article or propylene resin-made article is sealed at a heat-seal temperature of about 120 to 200° C. using either the film or the laminate in accordance with the present invention, a sealing strength of from 0.3 to 2.0 kgf/cm² (29 to 196 kPa) can be obtained for said articles. Incidentally, it is generally said that a sealing strength of less than 0.3 kg/cm² (29 kPa) means an inferior sealing property, and that of more than 2.0 kg/cm² (196 kPa) means an inferior easy-unsealing property. The above-mentioned sealing strength can be measured by a method comprising the steps of:

(1) heat-sealing a plastic container and a cover to seal tightly the container with the cover,

(2) filling a gas into the sealed container to increase gradually a gas pressure in the container, and

(3) measuring a pressure in the container at the time when the sealing interface is broken (usually, this case often occurs), or when the container is unsealed owing to peeling of the cover, the measured pressure being regarded as the sealing strength.

### EXAMPLE

The present invention is explained with reference to the following Examples, which are not intended to limit the scope of the present invention.

1. Preparation of Laminated Film Used for Evaluation According to Dry-laminating Process

A laminated film used for evaluation was prepared according to a process comprising the steps of:

(1) coating an aliphatic ester adhesive on a frosted surface of a 25 μm thick aluminum foil (a substrate layer) having one frosted surface with a multi-purpose coater manufactured by YASUI SEIKI CO.,LTD., wherein the adhesive contains (a) 10 parts by weight of a base agent, a trade name of A515, manufactured by Takeda Chemical Industries, Ltd., (b) 1 part by weight of a curing agent, a trade name of A50, manufactured by said company, and (c) 18 parts by weight of ethyl acetate,

(2) removing ethyl acetate completely,

(3) contacting and pressure-sealing the surface of the above-mentioned aluminum foil, to which the aliphatic ester adhesive has been coated, and a corona-treated surface of the film in accordance with the present invention to obtain a laminate, wherein the corona treatment has been carried out at the time of forming the film under conditions so as to obtain the corona-treated surface having a surface tension of not less than 42 dyne/cm, and

(4) aging the laminate at 40° C. for 48 hours in a dryer to obtain a laminated film used for evaluation.

2. Measurement of Liquid-Existing Sealing Strength

The liquid-existing sealing strength was measured by a process comprising the steps of:

(1) coating about 0.05 mg of a sugar aqueous solution having a concentration of 20% by weight on a surface of a flange portion of a rubber modified polystyrene-made cup (diameter of opening=24 mm, flange width=2 mm),

(2) putting a laminated film in accordance with the present invention on the above-mentioned coated surface so as to arrange the layer comprising the resin composition, which contains the components (A), (B) and (C), in the downward direction, wherein the laminated film has a shape of a cover,

(3) sealing it at 120° C. for 1 second under pressure of 1.4 kgf/cm² (137 kPa) with a desk cup sealer manufactured by NISSAN KOHKI CO., LTD. to obtain a sample used for evaluation,

(4) making a hole of 1 mmφ at the bottom of the sample cup used for evaluation, and

(5) measuring a strength required for peeling the cover from the flange of the cup with a puncture tester manufactured by NISSAN KOHKI CO., LTD., the measured force being regarded as the liquid-existing sealing strength.

### Example 1

100 Parts by weight of a rubber modified polystyrene (HIPS), a trade name of JPS H550, manufactured by JAPAN POLYSTYRENE INC., 800 parts by weight of an ethylene-methyl acrylate copolymer, a trade name of ACRYFT CG4002 (methyl acrylate unit content=31% by weight, ethylene unit content=69% by weight), manufactured by Sumitomo Chemical Co., Ltd., 100 parts by weight of hydrogenated terpene resin, a trade name of CLEARON P125 (number average molecular weight measured by a gel permeation chromatography=700), manufactured by Yasuhara Chemical Co., Ltd., 8 parts by weight of a lubricant, a mixture of erucic acid amide and ethylenebisoleic acid amide, and 15 parts by weight of polymethyl methacrylate beads (average particle diameter=10 μm) were melt-mixed at a cylinder temperature of 190° C. with an equal directional twin screw extruder, thereby obtaining a pellet of a resin composition (1).

On the other hand, 100 parts by weight of a rubber modified polystyrene (HIPS), a trade name of JPS H550, manufactured by JAPAN POLYSTYRENE INC., 350 parts by weight of a low density polyethylene (LDPE), a trade name of SUMIKATHENE (melt flow rate=2 g/10 min., density=0.924 g/cm³), manufactured by Sumitomo Chemical Co. Ltd., and 50 parts by weight of a hydrogenated styrene-isoprene block copolymer, a trade name of SEPTON 2104, manufactured by Kuraray Co., Ltd., were melt-mixed at a cylinder temperature of 190° C. with an equal directional twin screw extruder, thereby obtaining a pellet of a resin composition (2).

The pellets of the above-mentioned resin compositions (1) and (2) were subjected to film formation at an extrusion temperature of 230° C. with a 3-kind-3-layer T-die cast molding machine manufactured by CHUGAI TECH CO., LTD., thereby obtaining a film. The film had a thickness, namely, a thickness of the layer comprising the resin composition (1)/a thickness of the layer comprising the resin composition (1)/a thickness of the layer comprising the resin composition (2)=10/17/13 (μm). The surface of the outermost layer of the film, which layer comprised the resin composition (2), was subjected to a corona treatment, thereby obtaining a corona-treated film. The liquid-existing sealing strength of the corona-treated film was found to be 0.55 kgf/cm² (54 kPa).

### Example 2

Example 1 was repeated except that, in the production of the pellet of the resin composition (1), the amounts of the ethylene-methyl acrylate copolymer, the hydrogenated terpene resin and the lubricant were changed to 700 parts by weight, 200 parts by weight and 12.5 parts by weight, respectively, thereby obtaining a pellet of a resin composition (3).

On the other hand, Example 1 was repeated except that, in the production of the pellet of the resin composition (1), the amounts of the ethylene-methyl acrylate copolymer, the hydrogenated terpene resin and the lubricant were changed to 125 parts by weight, 25 parts by weight and 3.8 parts by weight, respectively, thereby obtaining a pellet of a resin composition (4).

Further on the other hand, Example 1 was repeated except that, in the production of the pellet of the resin composition (2), the rubber modified polystyrene and the low density polyethylene were changed to a rubber modified polystyrene, a trade name of JPS H320, manufactured by JAPAN POLYSTYRENE INC., and a low density polyethylene, a trade name of SUMIKATHENE L5715 (melt flow rate=9.5 g/10 min., density=0.930 g/cm³), manufactured by Sumitomo Chemical Co., Ltd., respectively, thereby obtaining a pellet of a resin composition (5).

In a similar manner to that of Example 1, the pellets of the above-mentioned resin compositions (3), (4) and (5) were subjected to film formation to obtain a film. The film had a thickness, namely, a thickness of the layer comprising the resin composition (3)/a thickness of the layer comprising the resin composition (4)/a thickness of the layer comprising the resin composition (5)=20/10/10 (μm). The surface of the outermost layer of the film, which layer comprised the resin composition (5), was subjected to a corona treatment, thereby obtaining a corona-treated film. The liquid-existing sealing strength of the corona-treated film was found to be 1.07 kgf/cm² (105 kPa).

### Example 3

Example 1 was repeated except that, in the production of the pellet of the resin composition (1), the amounts of the ethylene-methyl acrylate copolymer and the lubricant were changed to 700 parts by weight and 12.5 parts by weight, respectively, and 200 parts by weight of the hydrogenated terpene resin was changed to 200 parts by weight of a rosin ester, a trade name of PINECRYSTAL KE100 (number average molecular weight measured by a gel permeation chromatography=800), manufactured by Arakawa Chemical Industries, Ltd., thereby obtaining a pellet of a resin composition (6).

On the other hand, Example 1 was repeated except that, in the production of the pellet of the resin composition (2), the rubber modified polystyrene and the low density polyethylene were changed to a rubber modified polystyrene, a trade name of JPS H320, manufactured by JAPAN POLYSTYRENE INC., and a low density polyethylene, a trade name of SUMIKATHENE L5715 (melt flow rate=9.5 g/10 min., density=0.930 g/cm³), manufactured by Sumitomo Chemical Co., Ltd., respectively, thereby obtaining a pellet of a resin composition (7).

In a similar manner to that of Example 1, the pellets of the above-mentioned resin compositions (6) and (7), and a polyethylene resin, a trade name of ADMER NF 550, manufactured by Mitsui Chemicals, Inc., were subjected to film formation to obtain a film. The film had a thickness, namely, a thickness of the layer comprising the resin composition (6)/a thickness of the layer comprising ADMER NF 550/a thickness of the layer comprising the resin composition (7)=20/1010 (μm). The surface of the outermost layer of the film, which layer comprised the resin composition (7), was subjected to a corona treatment, thereby obtaining a corona-treated film. The liquid-existing sealing strength of the corona-treated film was found to be 0.89 kgf/cm² (87 kPa).

Comparative Example 1

100 Parts by weight of a rubber modified polystyrene (HIPS), a trade name of JPS H550, manufactured by JAPAN POLYSTYRENE INC., and 150 parts by weight of an ethylene-methyl methacrylate copolymer, a trade name of ACRYFT WM403 (methyl methacrylate unit content=38% by weight, ethylene unit content=62% by weight), manufactured by Sumitomo Chemical Co., Ltd., were melt-mixed at a cylinder temperature of 190° C. with an equal directional twin screw extruder, thereby obtaining a pellet of a resin composition (8).

On the other hand, Example 1 was repeated except that, in the production of the pellet of the resin composition (2), the low density polyethylene was changed to a linear low density polyethylene (LLDPE), a trade name of SUMIKATHENE-E FV202 (melt flow rate=2 g/10 min., density=0.925 g/cm³), manufactured by Sumitomo Chemical Co., Ltd., thereby obtaining a pellet of a resin composition (9).

In a similar manner to that of Example 1, the pellets of the above-mentioned resin compositions (8) and (9), and a linear low density polyethylene (LLDPE), a trade name of SUMIKATHENE-E FV202, manufactured by Sumitomo Chemical Co., Ltd., were subjected to film formation to obtain a film. The film had a thickness, namely, a thickness of the layer comprising the resin composition (8)/a thickness of the layer comprising the resin composition (9)/a thickness of the layer comprising LLDPE=20/10/10 (μm). The surface of the outermost layer of the film, which layer comprised LLDPE, was subjected to a corona treatment, thereby obtaining a corona-treated film. The liquid-existing sealing strength of the corona-treated film was found to be 0.03 kgf/cm² (3 kPa).

1. A film having a layer, which layer comprises a resin composition containing:
(A) 100 parts by weight of at least one resin selected from the group consisting of a rubber modified polystyrene resin and a polystyrene resin,
(B) 120 to 1700 parts by weight of an ethylene-unsaturated carboxylic acid ester copolymer, and
(C) 10 to 250 parts by weight of at least one tackifier selected from the group consisting of an alicyclic hydrocarbon resin, a terpene resin, a rosin and an aliphatic hydrocarbon resin, the tackifier having a number average molecular weight of not more than 1500 measured by a gel permeation chromatography, provided that at least one outermost layer of the film is the layer comprising said resin composition.

2. The film according to claim 1, wherein a content of an unsaturated carboxylic acid ester unit contained in the component (B) is from 25 to 50% by weight based on 100% by weight of a total amount of the component (B).

3. The film according to claim 1, wherein a number average molecular weight of the component (C) measured by a gel permeation chromatography is from 300 to 1000.

4. The film according to claim 1, wherein the component (C) contains a hydrogenated terpene resin.

5. A laminate comprising:
(1) a layer (1), and
(2) a substrate layer (2), wherein the layer (1) comprises a film having a layer (a), which layer (a) comprises a resin composition containing:
(A) 100 parts by weight of at least one resin selected from the group consisting of a rubber modified polystyrene resin and a polystyrene resin,
(B) 120 to 1700 parts by weight of an ethylene-unsaturated carboxylic acid ester copolymer, and
(C) 10 to 250 parts by weight of at least one tackifier selected from the group consisting of an alicyclic hydrocarbon resin, a terpene resin, a rosin and an aliphatic hydrocarbon resin, the tackifier having a number average molecular weight of not more than 1500 measured by a gel permeation chromatography, provided that:
(i) at least one outermost layer of the film is the layer (a) comprising said resin composition, and
(ii) at least one outermost layer of the laminate is the layer (1).

6. The laminate according to claim 5, wherein a content of an unsaturated carboxylic acid ester unit contained in the component (B) is from 25 to 50% by weight based on 100% by weight of a total amount of the component (B).

7. The laminate according to claim 5, wherein a number average molecular weight of the component (C) measured by a gel permeation chromatography is from 300 to 1000.

8. The laminate according to claim 5, wherein the component (C) contains a hydrogenated terpene resin.
